(19) United States
(12) Patent Application Publication
(10) Pub. No.: US 2003/0161680 A1
(43) Pub. Date: Aug. 28, 2003

(54) Holding device

(76) Inventor: John G. Suckow, Huburtus, WI (US)

Correspondence Address: Willis B. Swartwout III, 617 Oxford Drive, P.O. Box 619, Hartland, WI, 53029-0619, US

(21) Appl. No.: 10/341,127

(22) Filed: Jan. 13, 2003

Related U.S. Application Data
(60) Provisional application No. 60/347,272, filed on Jan. 14, 2002.

(51) Int. Cl. F16B 11/00

(52) U.S. Cl. 403/265

(57) ABSTRACT

A holding device formed from a material having position memory adapted to be secured to a wall or pin-up board or the like including a flat planar structure of any desired geometric configuration provided with a mounting pin formed into the device for attachment to the surface and including a partially cut out portion having a manual pull thereon extending generally vertically from the opposite side of said device from the pin and adapting the cut out portion to be manually manipulated out of and into alignment with the remainder of said flat planar surface to temporarily hold thin structure such as paper between the planar surface and the cut out portion.

### BACKGROUND OF THE INVENTION

The present invention relates to holding devices and more particularly to a device as disclosed in my provisional Patent Application No. 60/347,272 filed Jan. 14, 2002 and designed to hold a thin item such as paper or this plastic or the like.

In the past it has been ordinary for a person having a memo, telephone message slip or other similar structure to attach it to a wall or pin up board with a thumb tack or pin. This was particularly bothersome when attaching something to a wall as repeatedly removing the tack or pin left a bigger and bigger hole which eventually would not hold anything.

### SUMMARY OF THE INVENTION

The present invention proposes to overcome the prior art problems by constructing a holding device which will hold the desired object on the wall while eliminating the repeated removal and reinsertion of the tack or pin which enlarges the opening.

The structure of the present invention is a body of any desired shape permanently provided with an inset pin or tack which can be inserted into a hole in drywall, pin up board or the like and the body provided with mechanism to grip a group of or a single sheet of paper or other similar thin material.

The present invention further proposes structure such as that previously described wherein the body of the device is provided with a clip mechanism portion continuously biased to a position to hold a thin paper or structure against the remainder of the body of the device.

Various other objects, advantages, modifications and changes will become apparent as this description proceeds without departing from the spirit of the invention and it is intended that theses various other objects, advantages, modifications and changes will be covered by the scope of the appended claims.

### BRIEF DESCRIPTION OF THE DRAWINGS

FIG. 1 is a vertical plan view of structure embodying the present invention;

FIG. 2 is a side vertical plan view, partially in vertical cross-section, of the structure shown in FIG. 1;

FIG. 3 is a frontal vertical plan view of the structure shown in FIG. 1 of the drawings showing details of one form of the structure of the present invention; and

FIG. 4 is an isometric view of the structure of the present invention.

### DETAILED DESCRIPTION OF A PREFERRED EMBODIMENT

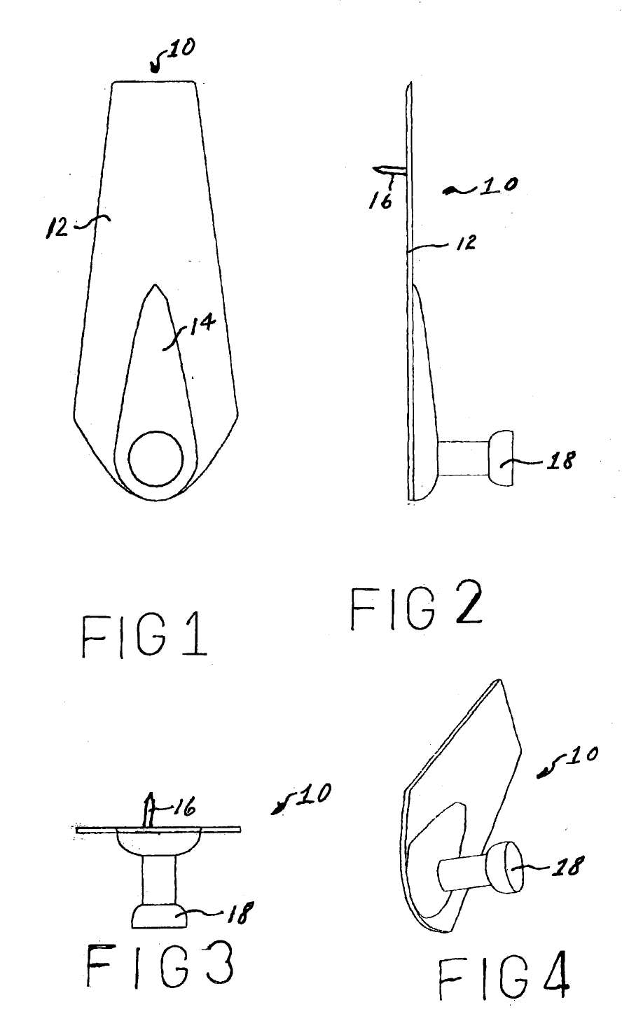

Referring now to the drawings and particularly to FIGS. 1 through 4 thereof, a holding device is disclosed and generally identified by the numeral 10. Device 10 is provided with a flat planer portion 12 from which is partially cut out a clamping device structure 14. The clamping device structure 14 is a part of portion 12 which is made from a plastic, metal or other similar material having a memory for position.

Flat planer portion 12 is provided with a pin or tack 16 molded or formed into and extending vertically from one side thereof adapting device 10 to be tacked or pinned onto a relatively flat surface such as a wall or pin-up board (not shown). Structure 14 is provided with a pull 18 extending vertically there from on the side of structure 14 and portion 12 opposite from tack of pin 16. Pull 18 allows a person to grasp structure 14 and lift it so that a thin paper, group of papers or calendar or the like may be temporarily affixed between structure 14 and portion 12 to be removably held until removal is desired simply by releasing pull 18 and allowing memory to return structure 14 to return to planar alignment with portion 12.

Thus it can be seen that the structure set forth accomplishes all of the objects and advantages for the invention as set forth previously herein.

1. A holding device for thin structures comprising:
a) a flat planar structure of any desired geometric configuration formed from a material having positional memory;
b) a partially cut out portion of said flat planar structure; and
c) a pin molded into and extending generally perpendicular to one surface of said flat planar structure adapting said flat planar structure to be temporarily affixed to a generally flat surface.

2. The structure as set forth in claim 1, wherein said partially cut out portion of said flat planar structure is provided with a manual pull extending generally vertically from said flat planar structure in the opposite vertical direction from said pin and on the opposite side of said flat device.

3. The structure set forth in claim 1, wherein the attached remainder of said flat planar structure and said device wherein said pull can be manually operated to lift said device extremity remote from said attached remainder temporarily out of planar alignment with flat planar structure to adapt the structure and the device to hold slender foreign objects.
